(19) United States
(12) Patent Application Publication
(10) Pub. No.: US 2005/0038131 A1
(43) Pub. Date: Feb. 17, 2005

(54) Impact cushioning foamed article

(76) Inventors: Takeshi Narishima, Tochigi-ken (JP); Tomohiro Onda, Tochigi-ken (JP); Ryuzo Horiguchi, Tochigi-ken (JP); Minoru Sawai, Wakayama-shi (JP)

Correspondence Address: BIRCH STEWART KOLASCH & BIRCH, PO BOX 747, FALLS CHURCH, VA, 22040-0747, US

(21) Appl. No.: 10/916,464

(22) Filed: Aug. 12, 2004

(30) Foreign Application Priority Data
Aug. 13, 2003 (JP) 2003-293057

(51) Int. Cl. C08J 9/00

(52) U.S. Cl. 521/50; 521/155

(57) ABSTRACT

An impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.; a member for shoe soles made of the impact cushioning foamed article; a member for carpeting made of the impact cushioning foamed article. The foamed article can be suitably used, for instance, as cushioning materials for shoe soles, carpets, artificial turfs and the like.

### FIELD OF THE INVENTION

The present invention relates to an impact cushioning foamed article. More specifically, the present invention relates to an impact cushioning foamed article which can be suitably used, for instance, as cushioning materials such as shoe soles, carpets and artificial turfs.

### BACKGROUND OF THE INVENTION

A foamed article represented by a polyurethane foam has been widely used in various fields. Among them, cushioning materials made of the foamed article for shoe soles, vehicles such as automobiles, furniture such as chairs and carpets, and beddings such as mattresses establish one of large industrial fields. Therefore, various types of foamed articles have been hitherto proposed for cushioning materials.

For instance, Japanese Patent Laid-Open No. Hei 11-286566 discloses a low-rebound resilient urethane foam (foamed article) having the peak value of a loss tangent tan δ at least 0.15 at a frequency of 10 Hz within a temperature range of −70° to −20° C., and the peak value of a loss tangent tan δ at least 0.3 at a frequency of 10 Hz within a temperature range of 0° to 60° C.; this urethane foam shows a low rebound resilience not only at room temperature but also at low temperatures of at most 0° C. Japanese Patent Laid-Open No. 2002-47330 discloses a low-rebound resilient polyurethane foamed article exhibiting both high extensibility and high tensile strength, which are controlled by adjusting its whole density to at most 600 kg/m³, a percent elongation to at least 300%, a tensile strength to at least 12 kg/cm², and a rebound resilience to at most 40%.

As described above, conventional foamed articles developed as some cushioning materials have a certain level of low rebound resilience and improved properties. However, the physical properties of those foamed articles are not determined from studying the correlation between (i) impact strength or impact time between feet and the ground during walking or running, and (ii) the physical properties of the foamed article such as viscoelasticity. Therefore, shoes soles made of such foamed articles do not necessarily provide the comfortableness when wearing the shoes. In some cases, the feet receive a great shock through the shoe soles upon landing of the feet since the shock absorbance of the foamed article is deficient. In other cases, tottering of the feet is caused since the rebound resilience of the foamed article is too small. In order to provide shoes being comfortable to wear and satisfying both high shock absorbance and low tottering of the feet, it is necessary to optimally design the viscoelastic properties of the foamed article, in particular, the dependence of the viscoelastic properties on frequency as described later.

On the other hand, in the development of the cushioning materials specialized for shoe soles, study has been focused mainly on outer soles made of a rubber-based material. Soles having specified complex modulus and loss coefficient (loss tangent) tan δ have been proposed for improving abrasion resistance and gripping property (anti-slipping property) against the ground (for instance, see Japanese Patent Laid-Open Nos. Hei 7-177903, Hei 10-17717 and 2002-78505). Japanese Patent Laid-Open No. Hei 7-177903 discloses an outer sole having a loss coefficient tan δ of at least 0.10 and a complex modulus of at least 180 kgf/cm² at a frequency of 10 Hz and a temperature of −15° C. Japanese Patent Laid-Open No. Hei 10-17717 discloses an outer sole comprising a rubber composition having a peak value of a loss coefficient tan δ being within a temperature range of −30° to −15° C. Japanese Patent Laid-Open No. 2002-78505 discloses an outer sole having a complex modulus of at least 15 MPa and a loss coefficient of at least 0.50 at a frequency of 10 Hz and a temperature of −10° C.

However, the outer soles disclosed in Japanese Patent Laid-Open Nos. Hei 7-177903, Hei 10-17717 and 2002-78505 are produced to improve gripping property of the rubber-based outer soles against the ground, and those outer soles having viscoelastic properties as defined in the above numerical ranges do not necessarily attenuate shock to the feet during walking or running. Further, in order to realize high shock absorbance, the cushioning material needs to have viscoelastic property with specified frequency dependence, as described later. Therefore, determining the viscoelastic property only at a single frequency (10 Hz) as in the above is insufficient for giving high shock absorbance to a foamed article.

Also, there has been proposed a shoe sole unit having a region comprising an elastic material having an energy loss of at most a given value, and a region comprising a viscous material having an energy loss of at least a given value (for instance, see Japanese Patent Laid-Open No. Hei 11-318508). This shoe sole unit is produced to attenuate shock to the heel by using a viscous material having an energy loss of at least 55% in the heel portions. However, simple adjustment of the energy loss (conversion of kinetic energy to thermal energy) in the internal of the viscous material to a given value or more would not necessarily attenuate the shock to the feet as described later. Also, the viscous material is not designed to satisfy both reduction of tottering feel of the feet and shock absorbance.

In general, one can attenuate the shock on the feet during walking or running by providing a sufficiently soft elastic member between the feet and the ground as a cushioning material. However, the feet will be tottered if such an elastic member is used as, for instance, a member of shoe soles, since the shoe soles are significantly shrunk upon landing of the feet on the ground, thereby making one less easily walkable with those shoes.

As described above, in order to provide comfortable shoes, it is necessary to optimally design the viscoelastic properties of the member for shoe soles used as a cushioning material so that the shock on the feet is attenuated while suppressing the deformation (shrinkage) of the member as little as possible. When the elastic modulus is too large, the rebound shock to the feet is increased. Also, when the elastic modulus is too small, the deformation (shrinkage) becomes large. In addition, when the energy loss is too small, the kinetic energy of the feet cannot be absorbed, so that the shock is not attenuated. On the other hand, when the energy loss is too large, dramatically large energy absorbance is generated in the cushioning material immediately after landing of the feet, so that the shock to the feet is rather increased. Moreover, it is necessary that the cushioning material used for a member of shoe soles has a certain light weight and sufficient strength for repeated shrinkage and recovery motions.

### SUMMARY OF THE INVENTION

The present invention relates to:
(1) an impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.;
(2) a member for shoe soles made of an impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.; and
(3) a member for carpeting made of an impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.

### BRIEF DESCRIPTION OF THE DRAWINGS

FIG. 1(a) is a graph showing frequency dependencies of storage modulus and loss tangent of a polyurethane foam obtained in Example 1 of the present invention, and FIG. 1(b) a graph showing frequency dependencies of storage modulus and loss tangent of a polyurethane foam obtained in Comparative Example 2.

### DETAILED DESCRIPTION OF THE INVENTION

The present invention relates to an impact cushioning foamed article being capable of absorbing and attenuating shock upon impact effectively with a small deformation (shrinkage) when the foamed article is inserted between two objects to be impacted, especially between the feet and the ground, and having both satisfactory strength and light weight at the same time. The present invention further relates to a member of shoe soles being capable of attenuating shock to the feet during walking or running, or a member for carpeting such as carpets and artificial turfs being capable of attenuating shock to the feet during walking or running.

The foamed article of the present invention has satisfactory strength and light weight, and absorbs or attenuates the shock upon impact with a small deformation (shrinkage) when the foamed article is inserted between two objects to be impacted with each other, especially between the feet and the ground. Therefore, the foamed article of the present invention can be suitably used, for instance, as a member for shoe soles and a member for carpeting, such as a carpet or artificial turf.

These and other advantages of the present invention will be apparent from the following description.

The present inventors have intensively studied in order to obtain a foamed article exhibiting excellent effects of absorbing or attenuating the shock upon impact when inserted between two objects to be impacted with each other, especially between the feet and the ground. As a result, it has been found out that the above effects are strongly exhibited by controlling storage modulus, loss tangent and porosity of the foamed articles to specified ranges.

It has been further found out that comfortable shoes giving a small shock to the feet landing on the ground and having little tottering of the feet are obtained when this foamed article is used as a member for shoe soles. Moreover, it has been found out that carpeting giving excellent soft feel to the feet and little tottering of the feet upon walking or running is obtained when this foamed article is used as an under-carpeting layer (member for carpeting) of the carpeting, such as a carpet or artificial turf.

The storage modulus E′(f) refers to a component of the modulus (complex modulus) that is inphase with a sinusoidal strain with a frequency f applied to a viscoelastic material such as a foamed article; that is, E′(f) is the real part of the complex modulus. The loss modulus E″(f) is defined as a component of the modulus (complex modulus) that has a phase shift of π/2 from an applied sinusoidal strain with a frequency f; that is, E″(f) is the imaginary part of the complex modulus. The ratio of the loss modulus E″(f) to the storage modulus E′(f), i.e. E″(f)/E′(f), is defined as loss tangent (tan δ).

When the feet are landed on the ground or the floor during walking or running, a large shock occurs at an initial impact between the feet and the ground or the floor. Since the time scale of this initial impact is assumed to be in the order of 5 to 100 msec, the frequency dependence of storage modulus and loss tangent in the range of 10 to 200 Hz, which corresponds to this time scale, determines the strength of the impact. Hence, it is important that the values of storage modulus and loss tangent within this frequency range are optimally adjusted. In the present invention, the frequency dependence of storage modulus and loss tangent of a foamed article within the range of 10 to 200 Hz is defined conveniently by selecting two frequencies of, for instance, 30 Hz and 100 Hz and specifying the numerical ranges for storage modulus and loss tangent at the above frequencies, whereby the viscoelasticity of the foamed article suitable for walking or running can be accurately determined. Further, a change in kinetic momentum (impact strength) occurring in the above initial impact can be estimated by multiplying the mass of 3 to 4 kg of the feet from the knee to a tip of the feet by a landing velocity of the feet of 0.2 to 1.0 m/sec. The foamed article in the present invention is designed to have viscoelasticity appropriate for attenuating this impact strength.

In the foamed article of the present invention, the storage modulus is 0.5 to 4.0 MPa, preferably 0.5 to 3.5 MPa at a frequency of 30 Hz and a temperature of 25° C. The storage modulus is at least 0.5 MPa, from the viewpoint of reducing the deformation (shrinkage) upon receiving a shock. Also, the storage modulus is at most 4.0 MPa, preferably at most 3.5 MPa, from the viewpoint of reducing rebound resilience of the foamed article and sufficiently absorbing the shock. In addition, the loss tangent is 0.18 to 0.80, preferably 0.25 to 0.80 at a frequency of 30 Hz and a temperature of 25° C. The loss tangent is at least 0.18, preferably at least 0.25, from the viewpoint of increasing the ability of absorbing kinetic energy of an impacted object, thereby sufficiently attenuating the shock to the feet. Also, the loss tangent is at most 0.80, from the viewpoint of suppressing the abrupt absorption of the kinetic energy in the foamed article immediately after the impact, and attenuating the shock to the feet.

In addition, the storage modulus is 0.5 to 4.5 MPa, preferably 0.5 to 4.0 MPa at a frequency of 100 Hz and a temperature of 25° C. The storage modulus is at least 0.5 MPa, from the viewpoint of reducing the deformation (shrinkage) upon receiving a shock. Also, the storage modulus is at most 4.5 MPa, preferably at most 4.0 MPa, from the viewpoint of reducing the rebound resilience of the foamed article and sufficiently absorbing the shock. In addition, the loss tangent is 0.35 to 1.0, preferably 0.4 to 1.0 at a frequency of 100 Hz and a temperature of 25° C. The loss tangent is at least 0.35, preferably at least 0.4, from the viewpoint of increasing the ability of absorbing kinetic energy of an impacted object, thereby sufficiently reducing the shock. Also, the loss tangent is at most 1.0, from the viewpoint of suppressing the abrupt absorption of the kinetic energy in the foamed article immediately after the impact, and attenuating the shock to the feet.

In the foamed article of the present invention, in addition to the frequencies of 30 Hz and 100 Hz, a different frequency (f) may be selected from the range of 10 to 200 Hz, and preferred ranges of storage moduli and loss tangents can be also defined at these three or more frequencies. More specifically, for instance, the foamed article of the present invention can be prepared so that a storage modulus is 0.5 to 2.0 MPa and a loss tangent is 0.16 to 0.5 at a frequency of 10 Hz and a temperature of 25° C., or the storage modulus is 1.7 to 2.5 MPa and the loss tangent is 0.01 to 0.14 at a frequency of 10 Hz and a temperature of 25° C. as well as satisfying the numerical ranges for storage moduli and loss tangents at the above frequencies of 30 Hz and 100 Hz.

The measurement of dynamic viscoelasticity for determining the storage modulus E′(f) and the loss tangent tan δ (f) can be carried out by generating compressive vibration in accordance with forced vibration method as follows: A very small static compressive strain (initial compressive strain) is applied to a test piece in the thickness direction, and thereafter a very small dynamic compressive strain which vibrates sinusoidally at a given frequency f is applied to the test piece. At this time, storage modulus E′(f) and loss modulus E″ (f) are obtained from the strain applied and the stress measured as a function of time, and the loss tangent tan δ (f) is calculated from the ratio of loss modulus E″ (f) to storage modulus E′(f).

In the present invention, the test piece used in the measurement of dynamic viscoelasticity has a cylindrical shape having a diameter of 18 mm and a thickness of 10 mm as a standard. Also, the initial compressive strain is 2%, and the amplitude of the applied dynamic strain is 3%. Here, the above strain (%) is expressed by a nominal strain in which a thickness of the test piece is used as a standard. In addition, the temperature at which the dynamic viscoelasticity of the foamed article is measured is preferably within an environmental temperature range of −5° to 40° C. where shoes, carpet, artificial turf or the like are daily used, and even more preferably within an average environmental temperature of 15° to 25° C. In the present invention, temperature for dynamic viscoelasticity measurement was adjusted to about 25° C.

In the foamed article of the present invention, the static elastic modulus in a linear region at a temperature of 25° C., i.e. a static elastic modulus against very small compressive strain, is preferably at least 0.4 MPa from the viewpoint of making the deformation (shrinkage) of the foamed article small, and preferably at most 3.8 MPa from the viewpoint of attenuating shock upon the impact.

The static elastic modulus can be measured with the use of a uniaxial-compression testing machine, as follows. In the testing machine, a test piece is subjected to compression and unloading at a very low speed (for instance, 0.5 mm/minute) in the direction of the thickness of the test piece, and a stress-strain curve is measured. Then, a static elastic modulus is calculated from the stress-strain curve obtained during the process of the unloading. It is preferable that the shape of the test piece used in the above measurement is the same as that in the dynamic viscoelasticity measurement. In the present invention, a cylindrical test piece having a diameter of 18 mm and a thickness of 10 mm is used as a standard.

The foamed article of the present invention has a porosity of 55 to 72%, preferably 60 to 70%. The porosity of the foamed article is adjusted to at least 55%, preferably at least 60%, from the viewpoint of reducing density of the foamed article, thereby reducing the weight of a manufactured article into which the foamed article is incorporated, and alleviating weariness accompanied with walking or running by reducing the weight of the shoes when the foamed article is used, for instance, as a member for shoe soles. In addition, the porosity of the foamed article is adjusted to at most 72%, preferably at most 70%, from the viewpoint of improving the strength of the foamed article, reducing the accumulation of the residual strains after being subjected to a large compression or repeated shrinkage and recovery in multiple times, and avoiding the phenomenon of not recovering its original thickness for a long period of time (for instance, several weeks).

The porosity of the foamed article can be obtained by taking an optical photomicrograph or an electronic photomicrograph of a cross section of the foamed article, and calculating the ratio of a total cross-sectional area of porous portions to the entire cross-sectional area.

If the strength of the foamed article is lowered, the accumulation amount of the residual strains is increased. The extent of the accumulation of the residual strains can be quantified by a so-called compressive permanent strain. Specifically, a test piece of a foamed article having a given thickness is compressed to one-half the original thickness to give 50% strain, and kept at the compressed state at 50° C. for 6 hours. Thereafter, the compression is released, and the test piece is allowed to stand for 30 minutes. The compressive permanent strain is obtained from the initial thickness and the final thickness of the foamed article on the basis of the equation:
[Compressive Permanent Strain]=([Initial Thickness−Final Thickness]÷[Initial Thickness÷2])×100.

In the foamed article of the present invention, the compressive permanent strain is preferably at most 25%, more preferably at most 20%, from the viewpoint of securing strength of the foamed article.

It is preferable that the foamed article has a single glass transition temperature, and that the glass transition temperature is within the temperature range of −20° to 60° C., since the foamed article of the present invention maintains its polymer crystallinity and orientation in an environmental temperature of −5° to 40° C. at which shoes are used.

The raw material used in the foamed article of the present invention includes self-foamable polyurethanes, rubbers, polyvinyl chloride, ethylene-vinyl acetate copolymers, olefinic resins, styrenic resins and the like. When a rubber, a polyvinyl chloride, an ethylene-vinyl acetate copolymer, an olefinic resin, a styrenic resin or the like is used, there can be employed a process comprising foaming a pre-foamed particle prepared by previously foaming these resins; a process comprising immersing a blowing agent in the resin and foaming the resin in a mold; and the like. Among the above-mentioned raw materials, polyurethane is preferable from the viewpoint of easily controlling the storage modulus, loss tangent and porosity and making the compressive permanent strain small.

The case where the foamed article is made of a polyurethane foam will be explained hereinbelow.

The polyurethane foam having porosity, storage modulus and loss tangent as defined in the present invention can be prepared by mixing in proper amounts a polyol (a), a chain extender (b), a polyisocyanate compound (c), a catalyst (d) and a blowing agent (e), and reacting these components.

The polyurethane foam contains a soft segment constituted by a polyol, and a hard segment constituted by an aggregate containing urethane bond or urea bond having a high bond energy. Since the behavior of dynamic viscoelasticity caused by this hard segment gives influences to the storage modulus and the loss tangent within the temperature range of −5° to 40° C., it is important to control this behavior.

It is preferable that the polyol is at least one member selected from the group consisting of a polyether-polyol having at least two hydroxyl groups (hereinafter simply referred to as “polyether-polyol”), a polymer-polyol comprising the polyether-polyol as a base material (hereinafter simply referred to as “polymer-polyol”) and a polyester-polyol.

The polyether-polyol includes, for instance, a polyether-polyol obtained by the addition polymerization of a polyhydric alcohol such as ethylene glycol, propylene glycol, 1,4-butanediol, neopentyl glycol, 1,6-hexanediol, glycerol, trimethylolpropane, 1,2,6-hexanetriol or pentaerythritol with an alkylene oxide; a polyoxytetramethylene glycol; and the like.

Representative examples of the polyether-polyol include a polyoxypropylene-based polyol having a molecular weight of at least 1500 per one hydroxyl group, obtained by adding ethylene oxide to a terminal hydroxyl group of a polyoxypropylene-polyol; a polyoxytetramethylene glycol having a molecular weight of at least 1000 obtained by ring-opening polymerization of tetrahydrofuran; a mixture thereof; and the like.

Representative examples of the polymer-polyol include a polyether-polyol in which fine polymer particles obtained by polymerizing a polymerizable unsaturated group-containing monomer are dispersed; and the like. The polymer-polyol can be prepared, for instance, by a process including the steps of mixing fine polymer particles obtained by polymerizing a polymerizable unsaturated group-containing monomer with a polyether-polyol, and dispersing the fine polymer particles in the polyether-polyol; a process including the steps of polymerizing the above-mentioned polymerizable unsaturated group-containing monomer in the above-mentioned polyether-polyol, and dispersing the fine polymer particles obtained from the above-mentioned polymerizable unsaturated group-containing monomer in the polyether-polyol; and the like. Among these processes, the latter process is preferred because there can be easily obtained a polymer-polyol in which the fine polymer particles are uniformly dispersed in the polyether-polyol.

The polymerizable unsaturated group-containing monomer includes styrene; acrylonitrile; alkyl methacrylates of which alkyl group has 1 to 4 carbon atoms, such as methyl methacrylate, ethyl methacrylate and butyl methacrylate; glycidyl methacrylate; alkyl acrylates of which alkyl group has 1 to 4 carbon atoms such as methyl acrylate, ethyl acrylate and butyl acrylate; glycidyl acrylate; and the like. Those monomers can be used alone or in admixture of at least two kinds.

The polyester-polyol is, for instance, a condensate of a polyhydric alcohol such as ethylene glycol, propylene glycol, 1,4-butanediol, diethylene glycol, neopentyl glycol or trimethylolpropane, with a polybasic acid such as phthalic acid, maleic acid, malonic acid, succinic acid, adipic acid or terephthalic acid, which has a hydroxyl group at its terminal.

In order to obtain a polyurethane foam having sufficient strength and desired storage modulus and loss tangent while satisfying the conditions for dynamic viscoelasticity in the present invention, the molecular weights of the bifunctional polyol and the trifunctional polyol, and the weight ratio of these polyols can be adjusted.

The “conditions for dynamic viscoelasticity” as referred to herein mean that the storage modulus is 0.5 to 4 MPa and the loss tangent is 0.18 to 0.80 at a frequency of 30 Hz and a temperature of 25° C., and the storage modulus is 0.5 to 4.5 MPa and the loss tangent is 0.35 to 1.0 at a frequency of 100 Hz and a temperature of 25° C.

For instance, when strength, storage modulus and loss tangent are controlled only by a bifunctional polyol, it is preferable that crystallinity of the overall resin is improved by using the bifunctional polyol having a low molecular weight so that the soft segment is more likely to be influenced by the hard segment and the degree of freedom is lowered. By the above procedures, the conditions for dynamic viscoelasticity can be satisfied.

When the bifunctional polyol is used together with the trifunctional polyol, it is preferable to increase the crystallinity of the soft segment portion near the hard segment by using a given kind of the bifunctional polyol and controlling the molecular weight of the trifunctional polyol and the weight ratio of the bifunctional polyol to the trifunctional polyol. As described above, the conditions for dynamic viscoelasticity can be satisfied by controlling the molecular weight of the trifunctional polyol and the weight ratio of the bifunctional polyol to the trifunctional polyol.

The molecular weights of the bifunctional polyol and the trifunctional polyol and the weight ratio of the bifunctional polyol to the trifunctional polyol are important factors for obtaining a foamed article having a sufficient strength.

It is preferable that the bifunctional polyol has an average number of functional groups of 1.5 to 2.5 and a number-average molecular weight of 1000 to 5000, from the viewpoint of giving sufficient strength to the resulting foamed article.

It is preferable that the trifunctional polyol has an average number of functional groups of 2.5 to 3.5 and a number-average molecular weight of 2000 to 10000 from the viewpoint of improving initial reactivity, securing dimensional stability of a formed article and shortening the demolding time.

The weight ratio of the bifunctional polyol/the trifunctional polyol is preferably 30/70 to 80/20, more preferably 35/65 to 65/35, even more preferably 40/60 to 60/40, from the viewpoint of securing sufficient strength and dimensional stability of the formed article.

When a polyether-polyol is used as a bifunctional polyol, it is preferable that the polyether-polyol has an average number of functional groups of 1.5 to 2.5, and a number-average molecular weight of 1500 to 5000, from the viewpoint of giving sufficient strength. In addition, when a polyester-polyol is used as a bifunctional polyol, it is preferable that the polyester-polyol has an average number of functional groups of 1.5 to 2.5, and a number-average molecular weight of 1000 to 2500, from the viewpoint of giving sufficient strength and securing liquidity.

When a polyether-polyol is used as a trifunctional polyol, it is preferable that the polyether-polyol has an average number of functional groups of 2.5 to 3.5, and a number-average molecular weight of 2000 to 8000, from the viewpoint of dimensional stability of the formed article. Also, when a polyester-polyol is used as a trifunctional polyol, it is preferable that the polyester-polyol has an average number of functional groups of 2.5 to 3.5, and a number-average molecular weight of 2000 to 4000, from the viewpoint of securing dimensional stability of a formed article and liquidity of a polyether-polyol.

Among these polyols, the polyether-polyol is preferred, from the viewpoint of effectively absorbing and attenuating the shock upon the impact with small deformation (shrinkage). Especially, a foamed article satisfying dynamic viscoelastic conditions can be effectively formed by using a mixture prepared by mixing a bifunctional polyol having a number-average molecular weight of 3000 to 5000 and a trifunctional polyol having a number-average molecular weight of 4000 to 5500 in a weight ratio of the bifunctional polyol/the trifunctional polyol of 35/65 to 65/35, without intending to necessarily limit the number-average molecular weights and mixing ratios to those defined above.

As the chain extender, there can be used a compound having at least two active hydrogens in its molecule, and a number-average molecular weight of at most 1000.

Representative examples of the chain extender include polyhydric alcohols such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, dextrose and sorbitol; aliphatic polyamines such as ethylenediamine and hexamethylenediamine; aromatic polyamines; alkanolamines such as diethanolamine, triethanolamine and diisopropanolamine; modified products thereof; and the like. Those chain extenders can be used alone or in admixture of at least two kinds.

A preferred chain extender is at least one compound selected from the group consisting of ethylene glycol, diethylene glycol, 1,4-butanediol, pentaerythritol and a modified product thereof, each number-average molecular weight of which is at most 1000. Those chain extenders can be used alone or in admixture of at least two kinds.

The polyurethane foam satisfying the conditions for dynamic viscoelasticity and having sufficient strength and desired storage modulus and loss tangent can be obtained by adjusting the amount of the chain extender having a low molecular weight.

In general, the chain extender reacts with an isocyanate component to form a rigid hard segment. The behavior of the dynamic viscoelasticity caused by this hard segment directly affect the conditions for dynamic viscoelasticity. Since the increase in the amount of the chain extender also increases the size and the number of the hard segments, it is assumed that this increase leads to increase in storage modulus and loss tangent within the temperature range of −5° to 40° C.

However, when the amount of the chain extender is exceedingly large, it is led to increase in hardness and storage modulus of the urethane foam and worsening in feel. Therefore, it is preferable that the amount of the chain extender is 3 to 70 parts by weight based on 100 parts by weight of the polyol, from the viewpoint of obtaining a foamed article having soft and excellent feel.

Representative examples of the polyisocyanate compound include isocyanate prepolymers and the like.

The isocyanate prepolymer can be obtained by reacting a polyisocyanate monomer with a polyol in the presence of an excess polyisocyanate monomer with stirring by a conventional method.

Concrete examples of monomer used in the polyisocyanate compound include polyisocyanate compounds such as tolylene diisocyanate, m-phenylene diisocyanate, p-phenylene diisocyanate, xylylene diisocyanate, 4,4′-diphenylmethane diisocyanate, hexamethylene diisocyanate, isophorone diisocyanate, polymethylenepolyphenylene polyisocyanate such as polymethylenepolyphenylene diisocyanate, 3,3′-dimethyl-4,4′-biphenylene diisocyanate, 3,3′-dimethyl-4,4′-diphenylmethane diisocyanate, 3,3′-dichloro-4,4′-biphenylene diisocyanate, 1,5-naphthalene diisocyanate, their modified products, such as carbodiimide modified products and the like. Those monomers can be used alone or in admixture of at least two kinds. Among them, 4,4′-diphenylmethane diisocyanate, or a combined use of 4,4′-diphenylmethane diisocyanate and its carbodiimide modified product is preferable.

Among the isocyanate prepolymers, an isocyanate prepolymer obtained by using 4,4′-diphenylmethane diisocyanate and a carbodiimide modified product of 4,4′-diphenylmethane diisocyanate is preferable from the viewpoint of securing sufficient strength.

In the isocyanate prepolymer obtained by using the carbodiimide modified product of 4,4′-diphenylmethane diisocyanate, 4,4′-diphenylmethane diisocyanate may be also admixed therewith.

When the isocyanate prepolymer is prepared, there can be added an auxiliary as occasion demands.

As the above-mentioned auxiliaries, there can be used, for instance, auxiliaries which have been used in the preparation of the polyether-polyol as occasion demands, inhibitors for self-polymerization of an isocyanate prepolymer, including acid gases such as hydrogen chloride gas and sulfurous acid gas, acid chlorides such as acetyl chloride, benzoyl chloride and isophthalic acid chloride, phosphoric acid compounds such as phosphoric acid, monoethyl phosphate and diethyl phosphate, in order to inhibit self-polymerization of the isocyanate prepolymer. These auxiliaries can be used alone, or in admixture of at least two compounds.

The NCO % of the isocyanate prepolymer is preferably at least 10%, more preferably at least 15%, in order to avoid undesirably high viscosity which results in difficulties in molding with a low pressure blowing machine, and the NCO % of the isocyanate prepolymer is preferably at most 25%, more preferably at most 22%, even more preferably at most 20%, in order to avoid undesirably low viscosity which results in poor measuring accuracy in the blowing machine.

The isocyanate prepolymer is liquid at a temperature of at least 15° C. and dischargeable even at a low pressure. Therefore, the isocyanate prepolymer can be used for the production of a polyurethane foam even at a molding temperature of 40° to 50° C. without any problems.

It is preferable that the NCO % of the polyisocyanate compound is 10 to 25% from the viewpoint of the prevention of increase in liquid viscosity and storage stability of the liquid. The polyisocyanate monomer used for the polyisocyanate compound is preferably 4,4′-diphenylmethane diisocyanate from the viewpoint of obtaining a foamed article having sufficient mechanical strength.

The catalyst includes, for instance, TEDA [1,4-diazabicyclo[2.2.2]octane], N,N,N′,N′-tetramethylhexamethylenediamine, N,N,N′,N′-tetramethylpropylenediamine, N,N,N′,N′,N″-pentamethyldiethylenetriamine, trimethylaminoethylpiperazine, N,N-dimethylcyclohexylamine, N,N-dimethylbenzylamine, N-methylmorpholine, N-ethylmorpholine, triethylamine, tributylamine, bis(dimethylaminoalkyl)piperazine, N,N,N′,N′-tetramethylethylenediamine, N,N-diethylbenzylamine, bis(N,N-diethylaminoethyl) adipate, N,N,N′,N′-tetramethyl-1,3-butanediamine, N,N-dimethyl-β-phenylethylamine, 1,2-dimethylimidazole, 2-methylimidazole and the like. Those catalysts can be used alone or in admixture of at least two kinds. Among the catalysts, the tertiary amines are preferable from the viewpoint of improvement in the reaction rate.

As the catalyst other than the tertiary amine, there can be also used, for instance, organometallic compounds such as dibutyltin dilaurate, stannous oleate, cobalt naphthenate and lead naphthenate.

As the blowing agent used in the present invention, water is an essential component. A hydrocarbon, a chlorofluorocarbon, a hydrogenated fluorocarbon or like may coexist together with water. It is preferable to use water alone as the blowing agent, from the viewpoint of avoiding the depletion of ozone layer of the earth.

When water is used as a blowing agent, water generally reacts with a polyisocyanate compound to form a rigid hard segment. The behavior of dynamic viscoelasticity caused by this hard segment directly influences the conditions for dynamic viscoelasticity. Since the increased amount of water increases the size and number of the hard segment, it is assumed that the value of the loss tangent is increased within the temperature range of −5° to 40° C. However, the polyurethane foam has an increased porosity due to carbon dioxide gas generated by the reaction of the isocyanate with water (the polyurethane foam has a lower density). In order to realize the porosity as defined in the present invention, the amount of water as a blowing agent is preferably 0.3 to 2 parts by weight, more preferably 0.5 to 1.8 parts by weight, even more preferably 0.9 to 1.6 parts by weight, based on 100 parts by weight of the polyol. In this case, the density of the polyurethane foam is usually 0.25 to 0.5 g/cm³.

In the present invention, as auxiliaries, there can be used a silicone-based surfactant, a cross-linking agent, a pigment, an antioxidant, a yellowing preventive and the like.

The polyurethane foam having desired storage modulus and loss tangent and porosity, while satisfying the conditions for dynamic viscoelasticity, can be obtained by mixing a polyol, a chain extender, a polyisocyanate compound, a catalyst and a blowing agent in proper amounts to react these components, and controlling the ratio of the soft segment to the hard segment making up the polyurethane foam. Specifically, storage modulus, loss tangent and porosity can be, for instance, adjusted in the following manner: In order to make the storage modulus smaller (or larger), the molecular weight of the polyol is adjusted to be smaller (or larger), or in the case where plural kinds of polyols are blended, the blending ratio of the polyol having a lower molecular weight (or higher molecular weight) may be adjusted to be larger, or the amount of the chain extender may be adjusted to be smaller (or larger). In addition, in order to make the loss tangent smaller (or larger), the molecular weight of the polyol is adjusted to be larger (or smaller), or in the case where plural kinds of polyols are blended, the blending ratio of the polyol having a higher molecular weight (or lower molecular weight) may be adjusted to be larger, the amount of the chain extender may be adjusted to be smaller (or larger), or the amount of water, a blowing agent, may be adjusted to be smaller (or larger). In addition, in order to make the porosity smaller (larger), the amount of water, a blowing agent, is adjusted to be smaller (or larger).

It is desired that the ratio of the polyol to the polyisocyanate compound when reacted with each other is adjusted so that the isocyanate index becomes 60 to 110, preferably 60 to 105, more preferably 70 to 100.

The process for preparing a polyurethane foam includes, for instance, a process including the steps of mixing a polyol component obtained by previously mixing (a) a polyol, (b) a chain extender, (d) a catalyst, (e) a blowing agent and other auxiliaries while stirring, with (c) a polyisocyanate compound in a molding machine; injecting the resulting mixture into a mold; and allowing the mixture to foam, and the like. More specifically, for example, the polyurethane foam can be prepared by mixing the components for the polyol component with stirring using a tank or the like and controlling the temperature usually to about 40° C., and allowing the polyol component to react with the polyisocyanate compound using a foaming machine such as an automatically mixing and injecting foaming machine or an automatically blending and injecting foaming machine to foam.

In the present specification, the embodiment is described by taking a polyurethane foam prepared by reacting a polyol with an isocyanate compound as an example, without intending to limit the foamed article of the present invention necessary to these polyurethane foams.

The foamed article of the present invention is suitable for attenuating the impact of the feet with the ground or the impact of the feet with the floor upon walking and running. Especially, the foamed article can be suitably used as a foamed article for shoe soles. Preferred applications of the foamed article include shoe soles for men's shoes, women's shoes, children's shoes, sandals, sport shoes, and the like. In general, a shoe sole comprises members classified into an outer sole used for sandals, men's shoes and the like, a midsole used for men's shoes, sport shoes and the like, and an inner sole inserted to the internal of the shoe. The present invention can be suitably used for these members for shoe soles. Among them, midsoles and inner soles inserted to the internal of the shoe are preferable from the viewpoint of exhibiting the effects by the foamed article.

The foamed article of the present invention can be used as members for carpeting such as members for carpets and members for artificial turfs. By providing an under-carpeting layer made of the foamed article of the present invention, the shock from the floor or the ground is attenuated when an individual walks (or runs) over the carpet or artificial turf, whereby excellent walking feel (running feel), which is soft to feet and little tottering on the carpeting, can be obtained.

The foamed article of the present invention can be used as a board-shaped member having a thickness of 2 to 50 mm, in which the thickness of the member may be spatially uneven. For instance, when the foamed article is used as a midsole for shoes, the foamed article has the same constitution in which the heel portion is thickened and the toe portion is thinned.

### EXAMPLES

The following examples further describe and demonstrate embodiments of the present invention. The examples are given solely for the purposes of illustration and are not to be construed as limitations of the present invention.

### Examples 1 to 3 and Comparative Examples 1 to 3

A polyol component was reacted with a polyisocyanate in accordance with the following method, to give a polyurethane foam.

First, a polyol, a chain extender, a catalyst, water as a blowing agent, a surfactant and a white pigment were mixed together to give a polyol component having the components shown in Table 1. Further, the ratio of the polyol component to the polyisocyanate was adjusted so that isocyanate index became the value as shown in Table 1. The isocyanate index was calculated on the basis of the equation:
[Isocyanate Index]=([Amount of Polyisocyanate Actually Used]÷[Amount of Polyisocyanate Stoichiometrically Equivalent to Polyol])×100.

TABLE 1

| | Polyol Component (Parts by Weight) | | | | | | | | | | | |
|---|---|---|---|---|---|---|---|---|---|---|---|---|
| | | | | | | | | Blowing | | | | |
| | Polyol | | Chain Extender | | | | | Agent | | White | Kind of | Isocyanate |
| | PO1 | PO2 | CE1 | CE2 | CE3 | CE4 | Catalyst | (Water) | Surfactant | Pigment | Polyisocyanate | Index |
| Ex. No. | | | | | | | | | | | | |
| 1 | 60 | 40 | 5.7 | 0.3 | 3.2 | — | 0.6 | 1.3 | 1 | 2 | PI1 | 98 |
| 2 | — | 60 | 7.5 | 0.5 | 40 | — | 0.7 | 1.5 | 1 | 2.2 | PI1 | 61 |
| 3 | 50 | 30 | 5.4 | — | 20 | — | 0.7 | 0.5 | 1 | 4 | PI1 | 78 |
| Comp. | | | | | | | | | | | | |
| Ex. No. | | | | | | | | | | | | |
| 1 | 60 | 40 | 8.5 | — | 3 | — | 0.6 | 1.4 | 1 | 2 | PI1 | 85 |
| 2 | 100 | — | 5.9 | — | — | — | 0.8 | 0.7 | 1 | 2 | PI1 | 85 |
| 3 | 100 | — | — | — | — | 12.4 | 0.8 | 0.6 | 0.9 | 2 | PI1 | 98 |

An automated blending injection foaming machine commercially available from Polyurethane Engineering Co., Ltd., under the model name of MU-203S and Model No. 6-018 was charged with the polyol component prepared as described above and the polyisocyanate, and these components were mixed together at a temperature of 35° to 45° C. The resulting mixture was injected into a mold (a silicone mold releasing agent being applied to its internal) at a mold temperature of 45° to 55° C., and allowed to be foamed under the following molding conditions to give a polyurethane foam sample.

[Molding Conditions]

Reactivity: cream time of 5 to 15 seconds
Demolding time: 5.5 to 6.5 minutes

The abbreviations of the components used in each Example and each Comparative Example mean the followings:

[Polyol]

PO1: Polypropylene glycol commercially available from Asahi Glass Urethane K.K. under the trade name of PREMINOL 5005, number of functional groups: 2, hydroxyl value: 28 mg KOH/g, number-average molecular weight: 4000
PO2: Polypropylene triol commercially available from Asahi Glass Urethane K.K. under the trade name of EXENOL 820, number of functional groups: 3, hydroxyl value: 34 mg KOH/g, number-average molecular weight: 4900
   [Polyisocyanate]
PI1: Polyisocyanate commercially available from Kao Corporation under the trade name of EDDYFOAM B-6106M (NCO %: 16.0%, the isocyanate used in isocyanate prepolymer: 4,4′-diphenylmethane diisocyanate)
   [Chain Extender]
CE1: Ethylene glycol
CE2: Diethylene glycol
CE3: Modified product of pentaerythritol commercially available from Sanyo Chemical Industries, Ltd. under the trade name of SUNNIX HD-402, number of functional groups: 4, hydroxyl value: 405 mg KOH/g, number-average molecular weight: 550
CE4: 1,4-Butanediol
   [Catalyst]
   Triethylenediamine
   [Surfactant]
   Surfactant commercially available from Dow Corning Toray Silicone Co., Ltd. under the trade name of SRX-253
   [White Pigment]
   White pigment commercially available from DAINICHISEIKA COLOR & CHEMICALS MFG. CO., LTD. under the trade name of FTR White

Next, storage modulus and loss tangent were determined for each of the samples obtained. In the determinations, a dynamic viscoelastic analyzer DVA-225 commercially available from IT Keisoku Seigyo K.K. was used, and a cylindrical test piece having a diameter of 18 mm and a thickness of 10 mm cut out from the sample was used as a test sample. After applying 2% static compressive strain in the direction of its thickness, a sine wave-like dynamic strain having a 3% amplitude was applied to the test piece, and storage modulus and loss tangent were determined at 25° C. at a frequency of 30 Hz or 100 Hz. This strain is a nominal strain based on the thickness of the test piece as a standard.

Further, a pair of shoes were produced using the above-mentioned polyurethane foam as a midsole, and an individual with the shoes walked on a flat pavement to evaluate comfortableness to wear the shoes. At this time, the thickness of the midsole was about 10 mm in the heel portion, and about 5 mm in other portions.

In order to evaluate shock attenuating property of the polyurethane foam when used as a carpeting material such as carpet or artificial turf, the following drop test was carried out. A board-like test piece having a length of 50 mm, a width of 50 mm and a thickness of 10 mm was cut out from a polyurethane foam sample. The test piece was allowed to stand on concrete floor, and an iron weight having a weight of 4 kg, a length of 50 mm and a width of 50 mm was allowed to free-fall from a given height (about 3 mm) onto the test piece. The peak value of the shock acceleration generated by the weight was determined. The shock acceleration was determined by adhering an acceleration sensor commercially available from KYOWA ELECTRONIC INSTRUMENTS CO., LTD. under the trade name of ASM-1KBBV to the upper part of the iron weight, and measuring the acceleration with a voltage amplifier commercially available from KYOWA ELECTRONIC INSTRUMENTS CO., LTD. under the trade name of CDV-700A at a sampling cycle of 25 μsec. The test was carried out five times, and the average of the peak values obtained was used as a test value of the shock acceleration. In order to simulate the walking of an individual on a carpet, the weight of the iron weight was set at 4 kg which substantially corresponds to the weight of a foot from the knee to the tiptoe, and the height from the carpet to the iron weight when the iron weight was allowed to free-fall was adjusted to the height at which a foot begins a free-falling-like motion during walking, that is, about 3 mm.

Furthermore, porosity and density of the polyurethane foam samples obtained in Examples 1 to 3 were determined in accordance with the following methods. The porosity was obtained by observing a region of 1.8 mm×1.4 mm (magnification: 175-folds), or a region of 700 μm×500 μm (magnification: 500-folds) of the cross section of the foamed article, with an optical microscope, photographing an observed region, and calculating the ratio of the total area of porous portions to the entire cross-sectional area. The density was calculated by dividing the weight of the test piece having a length of 50 mm, a width of 50 mm and a thickness of 10 mm cut out from the polyurethane foam sample by its volume (25 cm³).

The results of Examples 1 to 3 are shown in Table 2, and the results of Comparative Examples 1 to 3 are shown in Table 3.

TABLE 2

| | Storage | Loss | Storage | Loss | | | | | |
|---|---|---|---|---|---|---|---|---|---|
| | Modulus | Tangent | Modulus | Tangent | | | Compressive | | Drop Test |
| | E′ | tan δ | E′ | tan δ | | | Permanent | Comfortableness | (Peak Value |
| | (30 Hz) | (30 Hz) | (100 Hz) | (100 Hz) | Porosity | Density | Strain | When Wearing | of Shock |
| Ex. No. | (MPa) | (—) | (MPa) | (—) | (%) | (g/cm³) | (%) | Shoes | Acceleration) |
| 1 | 1.54 | 0.465 | 2.09 | 0.498 | 70 | 0.35 | 16 | Excellent | 7.4 G |
| 2 | 0.61 | 0.485 | 0.79 | 0.731 | 57 | 0.30 | 20 | Excellent | 4.8 G |
| 3 | 1.73 | 0.393 | 2.23 | 0.472 | 61 | 0.35 | 19 | Excellent | 9.8 G |

TABLE 3

| | Storage | Loss | Storage | Loss | | | | | |
|---|---|---|---|---|---|---|---|---|---|
| | Modulus | Tangent | Modulus | Tangent | | | Compressive | | Drop Test |
| | E′ | tan δ | E′ | tan δ | | | Permanent | Comfortableness | (Peak Value |
| Comp. | (30 Hz) | (30 Hz) | (100 Hz) | (100 Hz) | Porosity | Density | Strain | When Wearing | of Shock |
| Ex. No. | (MPa) | (—) | (MPa) | (—) | (%) | (g/cm³) | (%) | Shoes | Acceleration) |
| 1 | 2.85 | 0.317 | 3.29 | 0.337 | — | 0.35 | — | Somewhat lacking | 11.1 G |
| | | | | | | | | soft feel | |
| 2 | 2.21 | 0.166 | 2.55 | 0.195 | — | 0.50 | — | Lacking soft feel | 15.0 G |
| 3 | 4.15 | 0.292 | 5.02 | 0.340 | — | 0.50 | — | Hard feel | 21.2 G |

Each of the polyurethane foams obtained in Examples 1 to 3 has a storage modulus of 0.5 to 4 MPa and a loss tangent of 0.18 to 0.80 at a frequency of 30 Hz and a temperature of 25° C., and also has a storage modulus of 0.5 to 4.5 MPa and a loss tangent of 0.35 to 1.0 at a frequency of 100 Hz and a temperature of 25° C. Therefore, when the polyurethane foam is used in the shoe sole such as midsole, the shoe sole gives the shoes excellent shock attenuating property and provides excellent comfortableness for the shoes. Further, since each of the polyurethane foams had a storage modulus of at least 0.5 MPa, the deformation of the sole (shrinkage) was suppressed, so that tottering of the feet in the shoes could be prevented. Also, since each of the polyurethane foams had a porosity of 55 to 72%, the weight of the shoes was not so increased, and the strength of the sole was retained, so that change in comfortableness due to residual strain of the sole was not felt when continuously walked with the shoes. Further, since the peak value of the shock acceleration was suppressed to less than 10 G in the drop test, it can be seen that the shock is efficiently absorbed and attenuated. The above G represents a gravitational acceleration (9.8 m/s²).

On the other hand, since the polyurethane foam obtained in Comparative Example 1 had a small loss tangent at 100 Hz, shock was not sufficiently absorbed and attenuated. Therefore, when this polyurethane foam was used as a shoe sole such as midsole, sufficient shock attenuating property was not imparted to the shoes, so that the shoes did not have soft feel. The polyurethane foam obtained in Comparative Example 2 had small loss tangent tan δ at the frequencies of 30 Hz and 100 Hz, so that the shoes did not have soft feel.

Since the polyurethane foam obtained in Comparative Example 3 has a high storage modulus at the frequencies of 30 Hz and 100 Hz, and has a small loss tangent at the frequency of 100 Hz, the polyurethane foam had hard feel. Also, the polyurethane foams obtained in Comparative Examples 1 to 3 had peak values of the shock acceleration of at least 10 G in the drop test, so that shock could not be satisfactorily attenuated as compared to the polyurethane foams obtained in Examples 1 to 3.

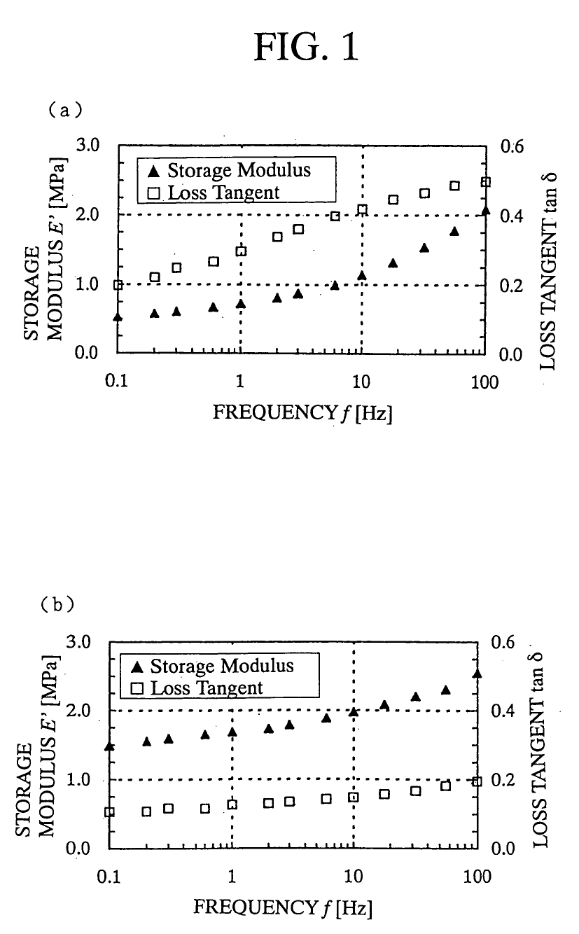

With respect to the polyurethane foams obtained in Example 1 and Comparative Example 2, storage moduli and loss tangents were determined for plural frequencies within the range of 0.1 to 100 Hz in the same manner as described above. The found values for Example 1 are shown in FIG. 1a, and the found values for Comparative Example 2 are shown in FIG. 1b.

In the case of Example 1, storage modulus is 1.1 MPa and loss tangent is 0.42 at a frequency of 10 Hz, both of which are within the preferred ranges, respectively (storage modulus: 0.5 to 2.0 MPa, loss tangent: 0.16 to 0.5). On the other hand, in the case of Comparative Example 2, storage modulus is 2.0 MPa and the loss tangent is 0.15 at a frequency of 10 Hz, which shows that the storage modulus is positioned on the boundary of the above-mentioned preferred range, and that the loss tangent is out of the above-mentioned preferred range.

### Comparative Examples 4 to 6

Three kinds of foamed articles made of an ethylene-vinyl acetate copolymer were used in Comparative Examples 4 to 6, and storage modulus, loss tangent, porosity and density were determined, and a drop test was carried out. The results are shown in Table 4.

TABLE 4

| | | Loss | | Loss | | | | |
|---|---|---|---|---|---|---|---|---|
| | Storage | Tangent | Storage | Tangent | | | Compressive | Drop Test |
| | Modulus E′ | tan δ | Modulus E′ | tan δ | | | Permanent | (Peak Value |
| Comp. | (30 Hz) | (30 Hz) | (100 Hz) | (100 Hz) | Porosity | Density | Strain | of Shock |
| Ex. No. | (MPa) | (—) | (MPa) | (—) | (%) | (g/cm³) | (%) | Acceleration) |
| 4 | 2.22 | 0.137 | 2.38 | 0.142 | 76 | 0.18 | 62 | 14.2 G |
| 5 | 4.18 | 0.129 | 4.49 | 0.138 | 77 | 0.24 | 65 | 20.1 G |
| 6 | 1.70 | 0.471 | 2.24 | 0.594 | 50 | 0.42 | 28 | 9.9 G |

It can be seen from the results shown in Table 4 that the foamed articles made of the ethylene-vinyl acetate copolymer obtained in Comparative Examples 4 and 5 have loss tangents of lower than 0.18 at 30 Hz, and loss tangents of lower than 0.35 at 100 Hz. Therefore, the energy upon the shock cannot be sufficiently absorbed, so that the peak value of the shock acceleration becomes a large value of at least 10 G in the drop test.

The foamed article made of the ethylene-vinyl acetate copolymer obtained in Comparative Example 6 has preferable values for both storage modulus and loss tangent and is excellent in shock attenuating property. However, the foamed article has a small porosity. Therefore, the foamed article is not suitable for shoe soles. In fact, since the density of the foamed article is as large as 0.42 g/cm³, it can be seen that the weight of the shoes is so increased as compared to the foamed articles obtained in Examples 1 to 3.

In addition, when a large compressive strain was once applied to the foamed articles made of the ethylene-vinyl acetate copolymer obtained in Comparative Examples 4 to 6, it was observed that the original dimensions are not readily recovered, whereby residual strains tend to remain for a long period of time. These foamed articles are not sufficient in strength. Therefore, when the foamed articles are used in shoe soles, there are some disadvantages such that the strains are gradually accumulated in the shoe soles during walking, so that feel such as comfortableness when wearing the shoes is changed.

In order to quantitatively evaluate the extent of the residual strains, compressive permanent strain was determined for the polyurethane foams obtained in Examples 1 to 3 and the foamed articles made of the ethylene-vinyl acetate copolymers obtained in Comparative Examples 4 to 6 in accordance with the following method. The results are shown in Tables 2 and 4.

(Method for Determination of Compressive Permanent Strain)

A foamed article was processed to have a disk-shaped test piece having a diameter of 32 mm and a thickness of 10 mm, and the test piece was compressed to a thickness of ½ by applying 50% strain and kept at that thickness at 50° C. for 6 hours. Thereafter, the compression was released from the test piece, and the test piece was allowed to stand for 30 minutes. Thereafter, the compressive permanent strain is obtained on the basis of the equation:
[Compressive Permanent Strain]=[Initial Thickness−Final Thickness]÷[Initial Thickness÷2]×100.

The larger the compressive permanent strain is, the lower the strength of the foamed article becomes, inferring that the larger the residual strains become. In the foamed articles made of the ethylene-vinyl acetate copolymers obtained in Comparative Examples 4 to 6, it can be seen that the values of the residual strains exceed 25%, which is clearly greater than those of the foamed articles obtained in Examples 1 to 3, that is, at most 25%. Especially, since each of the foamed articles obtained in Comparative Examples 4 and 5 has a large porosity, the compressive permanent strains are so large, and the strength of the foamed article is lowered.

### Comparative Example 7

A viscoelastic material made of an ether-based polyurethane commercially available from Sanshin Enterprise Co., Ltd. under the trade name of SORBO was used in Comparative Example 7, and in the same manner as in Examples 1 to 3, storage modulus, loss tangent and density were determined, and the drop test was carried out. The results are shown in Table 5. Since this viscoelastic material is not a foamed article, the porosity is zero.

TABLE 5

| | Storage | Loss Tangent | Storage | Loss Tangent | | Drop Test |
|---|---|---|---|---|---|---|
| | Modulus E′ | tan δ | Modulus E′ | tan δ | | (Peak Value |
| Comp. | (30 Hz) | (30 Hz) | (100 Hz) | (100 Hz) | Density | of Shock |
| Ex. No. | (MPa) | (—) | (MPa) | (—) | (g/cm³) | Acceleration) |
| 7 | 1.81 | 0.410 | 2.41 | 0.487 | 1.36 | 10.3 G |

The viscoelastic material used in Comparative Example 7 has preferable values for both storage modulus and loss tangent, and is excellent in shock attenuating property. However, since the porosity of the viscoelastic material is zero, the density is dramatically as high as 1.36 g/cm³. Therefore, when the shoes or carpeting is produced from the viscoelastic material, there are some disadvantages such that the weight of the shoes or carpeting is so increased. The increase in the weight of the shoes particularly brings fatigue to the feet during walking, so that this viscoelastic material is not suitable for shoe soles.

As described above, it is preferable that the materials for shoe soles or carpeting are produced from a foamed article having an appropriate porosity, which gives the materials both light weight and excellent strength. In addition to those properties, in order to give appropriate viscoelastic properties to the foamed article, it is effective that those materials are produced from a polyurethane foam prepared by reacting a polyol component with a polyisocyanate compound.

As explained above, since the foamed article has the above viscoelastic properties, the foamed article of the present invention can be suitably used, for instance, as cushioning materials for shoe soles, carpets, artificial turfs and the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.

2. The foamed article according to claim 1, wherein the foamed article is made of a polyurethane foam.

3. The foamed article according to claim 2, wherein the polyurethane foam is obtained by mixing (a) a polyol, (b) a chain extender, (c) a polyisocyanate compound, (d) a catalyst and (e) a blowing agent, and reacting the resulting mixture.

4. The foamed article according to claim 3, wherein (c) the polyisocyanate compound is an isocyanate prepolymer obtained from 4,4′-diphenylmethane diisocyanate or a carbodiimide modified product of 4,4′-diphenylmethane diisocyanate.

5. The foamed article according to claim 1, wherein the foamed article is used for shoe soles.

6. A member for shoe soles made of an impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.

7. The member according to claim 6, wherein the foamed article is made of a polyurethane foam.

8. The member according to claim 7, wherein the polyurethane foam is obtained by mixing (a) a polyol, (b) a chain extender, (c) a polyisocyanate compound, (d) a catalyst and (e) a blowing agent, and reacting the resulting mixture.

9. The member according to claim 8, wherein (c) the polyisocyanate compound is an isocyanate prepolymer obtained from 4,4′-diphenylmethane diisocyanate or a carbodiimide modified product of 4,4′-diphenylmethane diisocyanate.

10. A member for carpeting made of an impact cushioning foamed article having a porosity of 55 to 72%, a storage modulus of 0.5 to 4 MPa and a loss tangent of 0.18 to 0.80 at a frequency of 30 Hz and a temperature of 25° C., and a storage modulus of 0.5 to 4.5 MPa and a loss tangent of 0.35 to 1.0 at a frequency of 100 Hz and a temperature of 25° C.

11. The member according to claim 10, wherein the foamed article is made of a polyurethane foam.

12. The member according to claim 11, wherein the polyurethane foam is obtained by mixing (a) a polyol, (b) a chain extender, (c) a polyisocyanate compound, (d) a catalyst and (e) a blowing agent, and reacting the resulting mixture.

13. The member according to claim 12, wherein (c) the polyisocyanate compound is an isocyanate prepolymer obtained from 4,4′-diphenylmethane diisocyanate or a carbodiimide modified product of 4,4′-diphenylmethane diisocyanate.
